(19) United States
(12) Patent Application Publication
(10) Pub. No.: US 2003/0011714 A1
(43) Pub. Date: Jan. 16, 2003

(54) System and method for transmitting program data including immersive content

(76) Inventor: Robert W. Nevins JR., San Francisco, CA (US)

Correspondence Address: BEVER HOFFMAN & HARMS, LLP, 2099 GATEWAY PLACE, SUITE 320, SAN JOSE, CA, 951101017

(21) Appl. No.: 09/903,143

(22) Filed: Jul. 10, 2001

(51) Int. Cl. H04N 7/16; H04N 5/445; H04N 9/74; H04N 9/76

(52) U.S. Cl. 348/589; 348/563; 348/564; 348/600; 725/136

(57) ABSTRACT

A system and method for transmitting program data including immersive content is provided. A generated immersive video stream is first choreographed. Then, based on this choreography, the relevant macroblocks of the immersive video stream can be identified and compressed. At this point, the compressed macroblocks of the immersive video stream are ready for transmission to a distribution system. In one embodiment, a plurality of immersive video streams can be choreographed and compressed. These compressed immersive video streams can be multiplexed for transmission and subsequently de-multiplexed for display. Before display, the relevant macroblocks can be decompressed. In one embodiment, one or more terminals can display a plurality of previews associated with at least one program, and at least one preview can include immersive content. The plurality of previews can be individually or simultaneously activated.

### BACKGROUND OF THE INVENTION

1. Field of the Invention

The present invention relates to immersive content, and particularly to the manipulation and broadcast of immersive content.

2. Description of the Related Art

A program transmission system includes central equipment for receiving and distributing program signals to a plurality of viewer terminals (e.g. televisions, computers, etc.). FIG. 1 illustrates a known program transmission system 100 including program formatting unit 101, central equipment 103, and a cable system 107. Program formatting unit 101 typically assembles the program signals in digital form for transmission within program transmission system 100. Program formatting unit 101 can also generate information signals to accompany the program signals. Such information signals could include, for example, information regarding channel numbers, program titles, program lengths, and program start times. Central equipment 103 can receive program signals from program formatting unit 101 via a terrestrial link 111 or from a satellite 102 via a satellite link 110.

Central equipment 103 can provide signal conversion 104, signal processing 105, and signal storage 106. Specifically, the program signals received by central equipment 103 can be decoded or de-multiplexed (signal conversion 104), as necessary, and then filed (signal storage 106) for subsequent transmission over a cable system 107. Viewer requests received via terminals 108 are transferred to cable system 107. Central equipment 103 interprets these requests (signal processing 105) and transfers the appropriate program signals to cable system 107 accordingly.

Although program transmission system 100 can deliver conventional, digital cable programming, this system is ineffective in transmitting cutting edge program data, such as immersive content, for live broadcasts. Therefore, a need arises for a system and method of transmitting program data including immersive content.

### SUMMARY OF THE INVENTION

The present invention provides a system and method for transmitting program data including immersive content. In accordance with one method, a generated immersive video stream is first choreographed. This choreography can be performed by an operator or using software. Then, based on this choreography, the relevant macroblocks of the immersive video stream can be identified and compressed. At this point, the compressed macroblocks of the immersive video stream are ready for transmission.

In one embodiment, a plurality of immersive video streams can be choreographed and compressed. These compressed immersive video streams can be multiplexed for transmission and subsequently de-multiplexed for display. Before display, the relevant macroblocks can be decompressed.

In accordance with one feature of the invention, a program transmission system includes means for receiving and choreographing the immersive content, a macroblock selection unit, wherein each selected macroblock corresponds to a relevant macroblock of the immersive content as determined by the means for receiving and choreographing, and a compression unit to compress the selected macroblocks for transmission. The program transmission system typically includes a cable system that receives an output of the compression unit and provides at least one terminal for displaying the immersive content. The terminal can include a decompression unit to decompress the selected macroblocks. In one embodiment, the terminal can display a plurality of previews associated with at least one program, and at least one preview includes immersive content. The plurality of previews can be individually or simultaneously activated.

In accordance with one feature of the present invention, an on-screen directory displayed at a terminal includes a plurality of preview areas and a plurality of corresponding textual descriptions. Each preview area can include a predetermined segment of a program, wherein the segment shows representative action or drama of the program. The plurality of preview areas can be simultaneously or individually active. In the embodiment in which the preview areas are simultaneously active, one or more guides can indicate how to select a program or return to another directory. In the embodiment in which the preview areas are individually active, one or more guides can indicate how to preview a program, i.e. activate a preview area, select that program, or return to another directory.

In another embodiment of the invention, an onscreen display includes a plurality of preview areas and a selected program area. Typically, the selected program area is larger than each of the plurality of preview areas. In this embodiment, the plurality of preview areas can be individually or simultaneously active. In the embodiment in which the preview areas are simultaneously active, one or more guides can indicate how to select a program or return to another directory. In the embodiment in which the preview areas are individually active, one or more guides can indicate how to preview a program, i.e. activate a preview area, select that program, or return to another directory.

The on-screen directory including previews provides significant advantages over the known art. Specifically, a preview provides significantly more information than a mere listing of channels and their designations. Moreover, unlike those listings relying on written descriptions, a preview provides unbiased information to the viewer. Thus, the on-screen directory of the present invention, by showing representative action or drama of the program, allows the viewer to quickly identify a program of interest.

In accordance with one feature of the invention, at least one of the program can include immersive content, wherein the immersive content allows the location of a viewer within an environment to be moved. The viewer viewing immersive content can experience an event from any angle as if experiencing the event firsthand. For example, in a driving video, the viewer could have any angle as if the viewer were in the driver's seat of a car, thereby allowing the viewer to look left, right, ahead, above, and in the rear view mirror, as desired.

### BRIEF DESCRIPTION OF THE FIGURES

FIG. 1 illustrates a block diagram of a conventional program delivery system.

FIG. 2 is a three-dimensional representation of a viewer and an environment.

FIG. 3 is a three-dimensional representation for texture mapping a spherical environment on a cube.

FIG. 4 is a three-dimensional representation for texture mapping a spherical environment on a cylinder.

FIG. 5 illustrates a block diagram of a program delivery system in accordance with the present invention.

FIG. 6 is a diagram of a digital image separated into macroblocks.

FIG. 7 is a block diagram of a macroblock selection unit.

FIG. 8 is a block diagram of a video stream compressor.

FIG. 9 is a block diagram of a video stream decompression unit.

FIG. 10A illustrates one embodiment of an onscreen directory in accordance with the present invention.

FIG. 10B illustrates the on-screen directory of

FIG. 10A in which previews are simultaneously active.

FIG. 10C illustrates the on-screen directory of FIG. 10A in which previews are individually active.

FIG. 11A illustrates another embodiment of an on-screen directory in accordance with the present invention.

FIG. 11B illustrates the on-screen directory of FIG. 11A in which previews are simultaneously active.

FIG. 11C illustrates the on-screen directory of FIG. 11A in which previews are individually active.

### DETAILED DESCRIPTION OF THE FIGURES

Immersive Content

Program data can include immersive content to provide a dynamic environment for a viewer. For example, an immersive video can be made to capture a safari in the Serengeti, a car drive down Highway 1 in California, a concert with Madonna, or a plane ride through the Grand Canyon. Immersive video techniques provide a dynamic environment by allowing the location and the view window of the viewer to be simultaneously moved. Thus, in the California Highway 1 immersive video, the viewer could have the perspective of being in the driver's seat of a speeding Ferrari and look at the ocean, the sandstone cliffs, or the redwood forests, as desired.

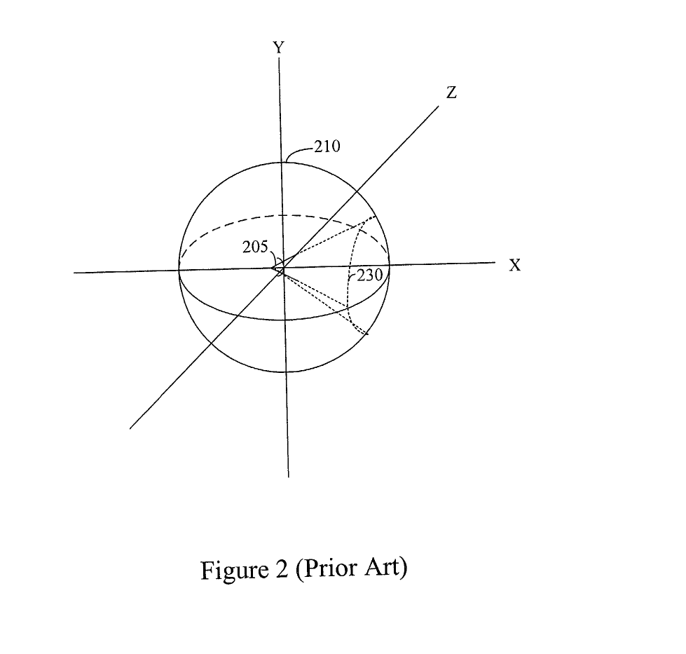

Immersive content is generated by providing multiple environment maps of three-dimensional spaces. FIG. 2 illustrates the construct used in one environment mapping system. A viewer 205 (represented by an angle with a curve across the angle) is centered at the origin of a three dimensional space having X, Y, and Z coordinates. The environment of viewer 205 (i.e. what the viewer can see) is ideally represented by a sphere 210, which surrounds viewer 205. Generally, for ease of calculation, sphere 210 is defined with a radius of 1 and is centered at the origin of the three dimensional space. More specifically, the environment of viewer 205 is captured and then re-projected onto the inner surface of sphere 210. Viewer 205 has a view window 230 which defines the amount of sphere 210 that viewer 205 can see at any given moment. View window 230 is typically displayed on a display unit for the viewer of the environment mapping system.

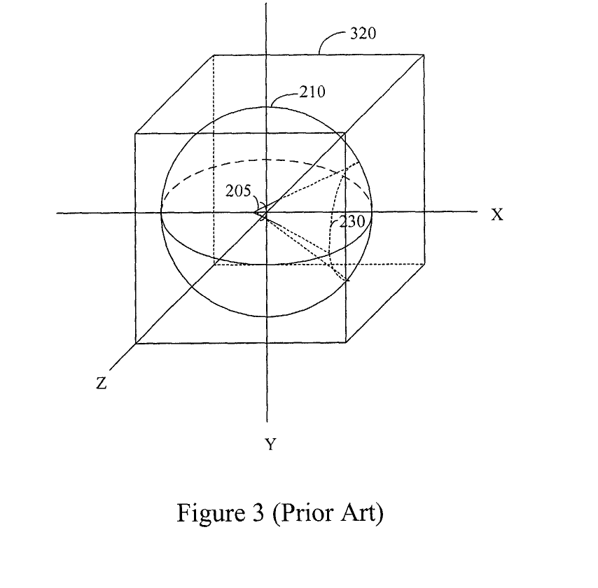

Computer graphic systems are generally not designed to process and display spherical surfaces. Thus, as illustrated in FIG. 3, texture mapping techniques are used to create a texture projection of the inner surface of sphere 210 onto polygonal surfaces of a regular solid (i.e. a platonic solid) having sides that are tangent to sphere 210. As illustrated in FIG. 3, a common texture projection is a cube 320 surrounding sphere 210. Specifically, the environment image on the inner surface of sphere 210 serves as a texture map, which is then texture mapped onto the inner surfaces of cube 320. A cube is typically used because most graphics systems are optimized to use rectangular displays and a cube provides six rectangular faces. The faces of the cube can be concatenated together to form the environment map. During viewing, the portions of the environment map that correspond to view window 230 (FIGS. 2 and 3) are displayed for viewer 205.

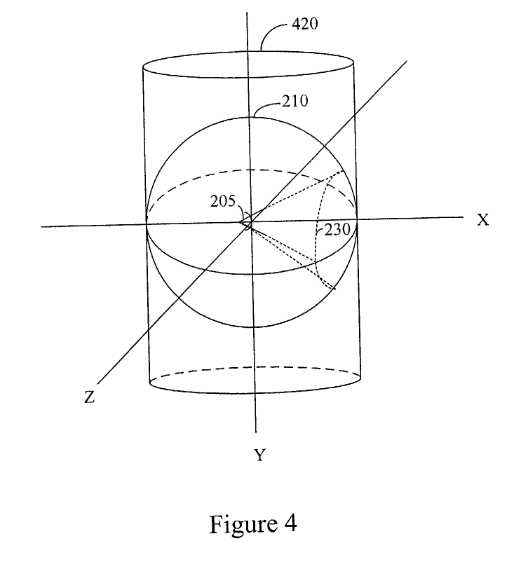

Other texture projections can also be used. For example, cylindrical mapping, as illustrated in FIG. 4, can be used if view window 230 is limited to a visible range around the equator. Specifically, in FIG. 4, a texture projection in the shape of a cylinder 420 surrounds sphere 210. The environment image on the inner surface of sphere 210 serves as a texture map, which is then texture mapped onto the inner surface of cylinder 420. Note that cylinder 420 can be approximated using a plurality of rectangular sides to simplify the texture mapping. Moreover, cylinder 420 may be “unrolled” to form a rectangular environment map. Texture mapping is described in further detail in the reference, “Texture Mapping as a Fundamental Drawing Primitive”, published in June, 1993 by Paul Haeberli and Mark Segal.

An immersive video stream comprises a series of individual digital images (also called frames), wherein each digital image is an environment map. For full motion immersive video, a video frame rate of 30 images per second is desired. A digital image comprises a plurality of picture elements (pixels), wherein each pixel can be identified using a 2 dimensional coordinate system. Typical image sizes for conventional digital video streams include 640×480, 320×240 and 160×120 pixels. However, image sizes for immersive video streams (i.e. environment map sizes) are typically much larger than conventional digital video streams. Some common image sizes for immersive video streams include 1024×1024 and 2048×2048 pixels.

Immersive Content Transmission System

Program transmission system 100 is unable to interpret and manipulate immersive program data for live broadcasting. Specifically, the complexity and size of the multiple environment maps comprising the immersive program data render conventional techniques and components used in program transmission system 100 ineffective. To address these issues, the present invention provides a system and method for transmitting program data including immersive content.

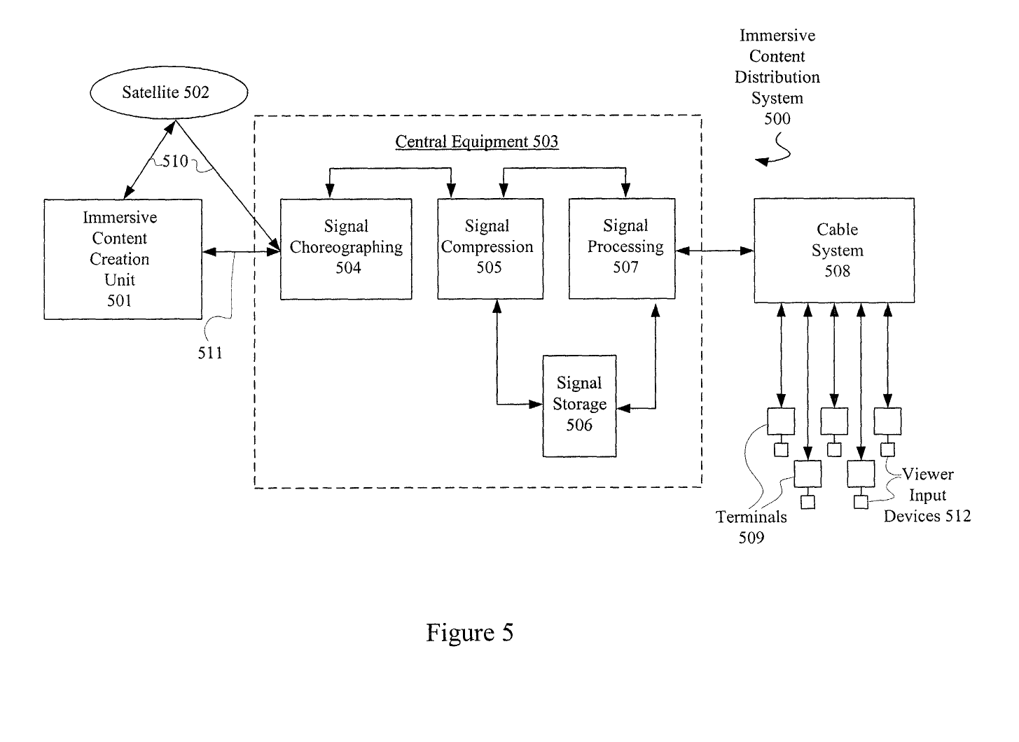

FIG. 5 illustrates a block diagram of an immersive content transmission system 500 that includes immersive content creation unit 501, central equipment 503, and a cable system 508 having at least one terminal 509. Immersive content creation unit 501 generates a digital video stream including multiple environment maps. Immersive content creation unit 501 can also generate information signals to accompany the digital video stream. Such information signals could include, for example, information regarding a channel number and a program title. Central equipment 503 can receive the immersive content from immersive content creation unit 501 via a terrestrial link 511 or from a satellite 502 via a satellite link 510.

Signal Choreographing

In accordance with the present invention, central equipment 503 can provide signal choreographing 504. During choreographing, the multiple environment maps are analyzed and at least one view window in each environment map is defined for transmission. This choreography can be performed by an operator or defined by software. In the case of operator input, the operator can use a standard viewer input device (e.g. a joy stick) to determine the view window. In the case of software definition, the software could begin with a predetermined view window, such as the view window of a driver looking at the road, to place the viewer in the context of the immersive video. Then, the view window could be changed according to predetermined parameters. These parameters could be based on viewer preferences (as determined by surveys, tests, or any other known methodology) or set to simulate a more realistic immersive experience. Thus, assuming that the immersive content simulated a car ride down Highway 1 in a Ferrari, the operator or software would determine what the viewers at terminals 509 would see.

Compression Schemes

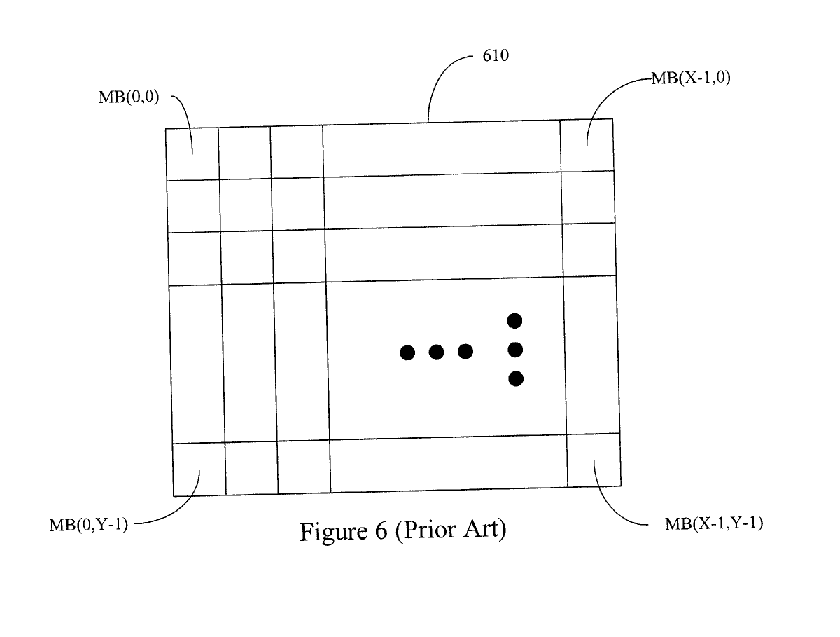

Because digital video streams, especially immersive video streams, contain considerable data, central equipment 503 can use signal compression 505 to reduce data storage and transfer requirements. Typical compression schemes define macroblocks, wherein a macroblock includes a plurality of adjacent pixels with a predetermined shape and size. A typical size for a macroblock is 16 pixels by 16 pixels. FIG. 6 illustrates a digital image 610 divided into a plurality of square macroblocks MB. In FIG. 6, digital image 610 has X columns and Y rows of macroblocks MB, thereby allowing each macroblock MB to be identified using a 2 dimensional coordinate system.

Various compression schemes can be used to compress digital video streams. One common technique for compressing a digital video stream is to transmit a difference frame, which contains data specifying the difference between previous or following frames rather than transferring each image of the video stream. For example, P frames and B frames used in MPEG compression would be classified as difference frames. Periodically, a self-contained frame can be transmitted so that errors caused by sending only difference frames do not accumulate beyond a reasonable level. As used herein, a self-contained frame contains all the data necessary to be fully decoded into an image. For example, an I frame (interframe) in MPEG compression is a self-contained frame as used herein. In MPEG compression, an I frame is typically transmitted every twelfth frame. However, in some embodiments of the present invention, a self-contained frame may be sent more often, such as once every fifth frame.

Generally, differences are calculated on a macroblock level. Thus, a difference frame contains difference macroblocks. However, some macroblocks within difference frames may be self-contained macroblocks. During encoding the macroblocks are first converted from a display color space such as RGB into a luminance based color space. In general, luminance based color spaces, such as YC_{b}Cᵣ, are used because the luminance signal provides most of the information needed for compression.

A difference macroblock can be calculated based on other macroblocks contained within the current frame or within frames in close temporal proximity with the current frame. Typically, a frame range FR is specified during encoding. For example, if the frame range FR is two frames, then the current frame and the two frames following the current frame can be used to encode the difference macroblock. In some compression schemes, instead of specifying a frame range FR, the frame range FR can be determined by the number and spacing of self-contained frames within the video stream. For these embodiments a maximum frame range can be determined for the video stream and used in place of the specified frame range.

In addition to temporal proximity, a difference macroblock can also be calculated based on macroblocks in close area proximity to the current macroblock. Typically, this area range AR is specified during encoding to determine the necessary level of area proximity. Various other schemes, such as motion estimation and discrete cosine transform coding, can also be used with macroblocks to further compress the video stream.

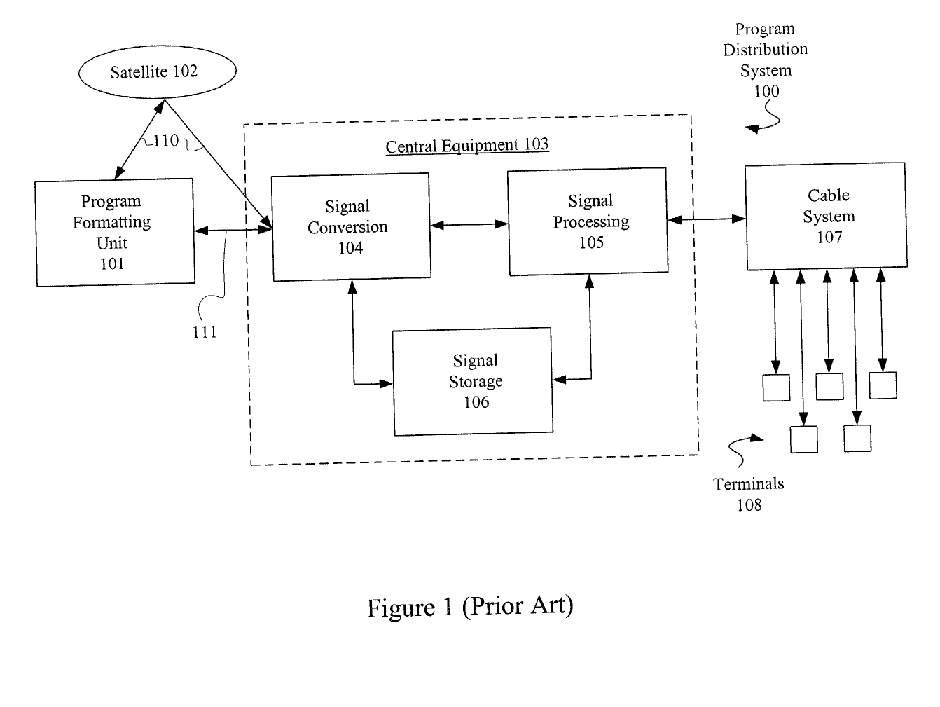

Because immersive video streams are significantly larger and contain far more data than standard video streams, compression (and subsequent decompression) of high resolution immersive video streams may be beyond central equipment 103 (FIG. 1) as well as the video display systems in terminals 108 designed for standard video streams. Thus, in accordance with one embodiment of the present invention, only the portion of the immersive video stream in view window 230 (FIG. 2) as determined by signal choreographing 504 (FIG. 5) is fully compressed. However, macroblocks near the edge of view window 230 may depend on macroblocks outside of view window 230. Thus, macroblocks near view window 230 may need to be partially or fully compressed in accordance with other embodiments of the present invention. As used herein, the term “relevant” macroblock refers to members of the subset of macroblocks that are necessary for creating the image in view window 230 as determined signal choreographing 504.

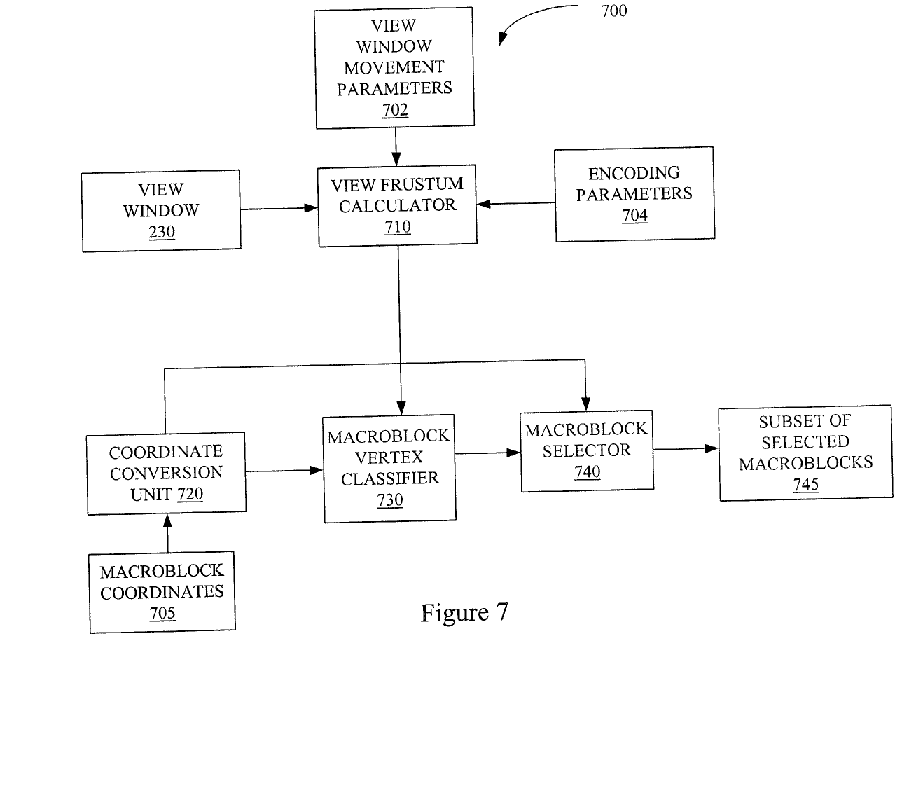

FIG. 7 is a block diagram of one embodiment of a macroblock selection unit 700 which can be used select a subset of selected macroblocks. In macroblock selection unit 700, a view frustum calculation unit 710 receives information regarding view window 230, view window motion parameters 702, and encoding parameters 704 to calculate an expanded view window for each frame. This expanded view window encompasses the relevant macroblocks within each frame.

View window motion parameters 702 include a maximum horizontal speed HSₘₐₓ and a maximum vertical speed VSₘₐₓ for view window 730. Generally, maximum horizontal speed HSₘₐₓ and maximum vertical speed VSₘₐₓ are defined using the unit pixels/frame. Thus, if maximum vertical speed VSₘₐₓ is equal to 5 pixels/frame, view window 230 can move up or down at a rate of 5 pixels per frame. In some embodiments, rather than using the speed of view window 230 in terms of pixels per frame, spatial parameters based on the viewpoint of viewer 205 is used. For example, parameters describing the angular rate at which the view frustum moves can be used in place of the speed of the view window. Encoding parameters 704 include the above-referenced frame range FR and area range AR. U.S. patent application Ser. No. 09/670,957, also filed by the assignee of the present invention, describes several exemplary definitions for frame range FR and area range AR in further detail.

After calculating the expanded view window, view frustum calculator 710 calculates the normal vectors of an expanded view frustum encompassing the expanded view window. A view frustum is the solid angle projection from viewer 205 (who is deemed to be at the origin), which encompasses the expanded view window. Generally, the expanded view window is rectangular, thus the expanded view frustum for the expanded view window would resemble a four-sided pyramid and have four normal vectors, i.e. one vector for each side of the expanded view frustum. In one embodiment, a view frustum normal vector points into and perpendicular to the plane containing a side of the expanded view frustum.

A macroblock vertex classifier 730 receives the calculated view frustum normal vectors as well as macroblock coordinates 705. A coordinate conversion unit 720 can convert the macroblock coordinates from environment map coordinates to spatial coordinates around viewer 205. Note that the coordinate system of the expanded view window can be the same as the coordinate system of the macroblocks, thereby rendering coordinate conversion unit 720 unnecessary.

Macroblock vertex classifier 730 uses the view frustum normal vectors to classify each vertex of every macroblock (four vertices for each macroblock MB in the embodiment shown in FIG. 6) to determine whether that vertex is above, below, left of, or right of the view frustum. The relationship of a vertex with the view frustum is computed using the inner product (or dot product) of the vertex with the view frustum normal vectors. For example, if the inner product of a vertex with the right side view frustum normal vector is less than zero, then the vertex is to the right of the view frustum. Similarly, if the inner product of a vertex with the left side view frustum normal vector is less than zero, then the vertex is to the left of the view frustum.

Macroblock vertex classifier 730 provides the vertex classifications to a macroblock selector 740. Macroblock selector 740 then selects a subset of selected macroblocks 745, wherein the subset includes any macroblock that has at least one vertex within the view frustum. In one embodiment, due to processing efficiencies, subset of selected macroblocks 745 can include some macroblocks other than relevant macroblocks. U.S. patent application Ser. No. 09/670,957, referenced herein, describes an exemplary macroblock selector 740.

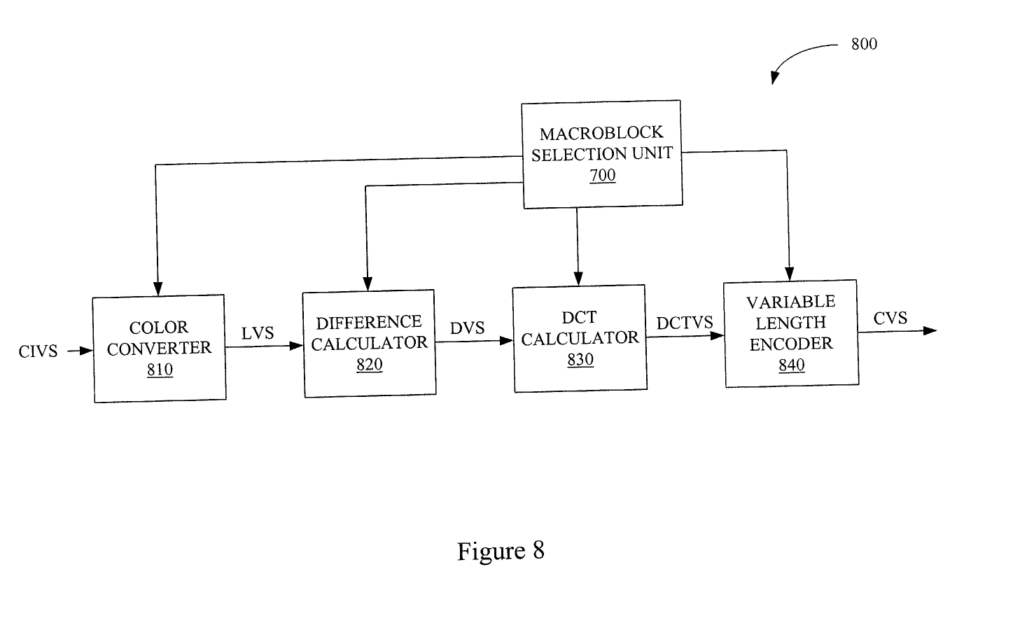

Once the relevant macroblocks are identified, the choreographed immersive program data can be compressed. FIG. 8 is a simplified block diagram of a video stream compressor 800 that receives input from macroblock selection unit 700. Video stream compressor 800 includes a color converter 810, a difference calculator 820, a discrete cosine transform (DCT) calculator 830, and a variable length encoder 840. Color converter 810 converts the choreographed immersive video stream CIVS into a luminance based video stream LVS. Specifically, color converter 810 converts the color space of each macroblock in choreographed immerisve video stream CIVS into a compressed macroblock color space, typically luminance based. Difference calculator 820 converts luminance-based video stream LVS into a difference video stream DVS, which has both self-contained frames and difference frames. Specifically, difference calculator 680 encodes a subset of the relevant macroblocks in luminance-based video stream LVS into difference macroblocks. DCT calculator 830 performs a discrete cosine transform on difference video stream DVS to create a discrete cosine transform video stream DCTVS. Specifically, each relevant macroblock is transformed into a DCT macroblock comprising DCT coefficients. Compression is achieved using DCT transforms by quantizing the DCT coefficients. Finally, variable length encoder 840 performs a final encoding to create a compressed video stream CVS. Specifically, variable length encoder 840 assigns different bit patterns to the DCT coefficient values of the DCT macroblocks. Compression is achieved by using shorter patterns for more common DCT coefficient values. Note that run length encoding can also be applied to the relevant macroblocks to further compress the video stream. Note that for illustration purposes, a compression scheme conforming to MPEG has been described. However, one skilled in the art can adapt the principles of the present invention to be used with a variety of compression schemes. For example, in accordance with another embodiment of the present invention, the compression standard called Digital Video (DV) can also be used. DV compression, in contrast to MPEG compression that reduces redundancy from frame-to-frame, reduces redundancy only within one frame. DV compression is explained in detail in U.S. Pat. No. 6,233,282, which issued to Adaptec, Inc. on May 15, 2001, and U.S. Pat. No. 6,215,909, which issued to Sony Electronics, Inc. on Apr. 10, 2001.

After signal compression 505 (FIG. 5), central equipment 503 can provide immediate signal processing 507 of the immersive video stream or signal storage 506 of the immersive video stream for subsequent distribution over cable system 508. Specifically, viewer requests generated by viewer input devices 512 and provided to terminals 509 are thereafter transferred to cable system 508 and then forwarded to central equipment 503. Central equipment 503 can interpret these requests (signal processing 507) and can transfer the appropriate program signals to cable system 508 accordingly.

A viewer request can be initiated using any standard viewer input device 512. For example, if terminal 509 is a television, then viewer input device 512 could include a remote control or a control panel. Such viewer input devices typically include buttons labeled with alpha, iconic, and numeric characters as well as movement cursors. If terminal 509 is a computer, then viewer input device 512 could include a mouse having the ability to move a cursor and select objects on-screen. Other types of viewer input devices 512, such as joysticks, can be used with various terminals 509.

Decompression of Immersive Content

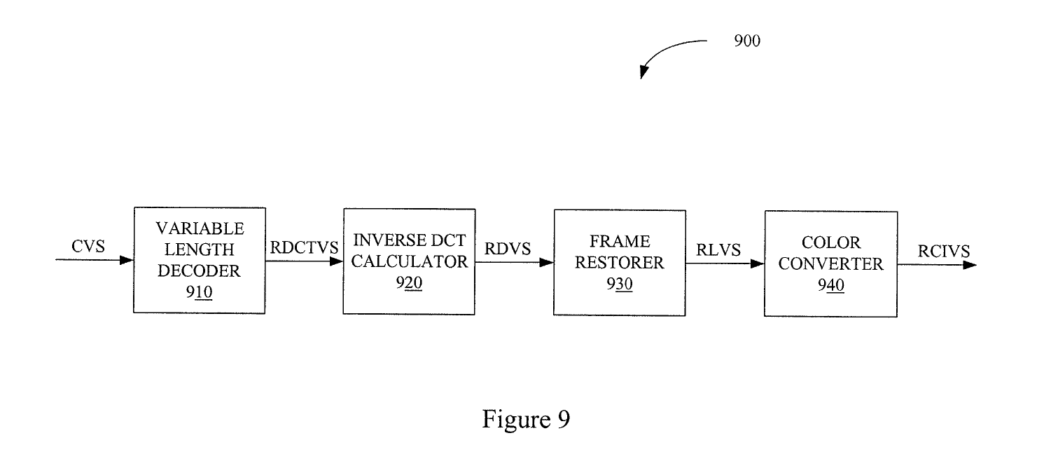

FIG. 9 is a block diagram of a video stream decompression unit 900 for incorporation into a terminal 509 in accordance to one embodiment of the present invention. In this embodiment, decompression unit 900 includes a variable length decoder 910, an inverse DCT calculator 920, a frame restorer 930, and a color converter 940. Variable length decoder 910 receives the compressed video stream CVS and decodes the variable length encoding performed by variable length encoder 840 (FIG. 8) to generate a restored discrete cosine transform video stream RDCTVS. Specifically, run length decoding is used to extract the DCT coefficients bit patterns of the relevant macroblocks and the bit patterns are converted to actual DCT coefficients. Inverse discrete cosine transform (DCT) calculator 920 receives restored discrete cosine transform video signal RDCTVS and generates a restored difference video stream RDVS by inverting the discrete cosine transform performed by DCT calculator 830 (FIG. 8) on the relevant macroblocks. A frame restorer 930 receives the restored difference video stream RDVS and generates a restored luminance based video stream RLVS. Specifically, frame restorer 930 reforms the relevant macroblocks from the difference macroblocks of restored difference video stream RDVS.

Finally, a color converter 940 converts the color space of the relevant macroblocks in restored luminance-based video stream to a color space suitable for the display systems of terminals 509 (FIG. 5). For example, in one embodiment of the present invention, the color space of the compressed macroblocks is 4:2:0 YCbCr and the color space for the display system is 4:4:4 RGB. Other luminance-based color spaces that may be used include 4:2:2 YCbCr and 4:4:4 YCbCr. In this manner, video stream decompression unit 900 outputs a restored, choreographed immersive video stream RCIVS to terminals 509.

On-Screen Directories

As described above, terminals 509 can include televisions, computers, or other viewer display systems. For illustration purposes, the following descriptions of various embodiments of on-screen directories assume that a terminal 509 includes a television and that the associated viewer input device 512 of that terminal 509 includes a remote control having at least numerical buttons. However, those skilled in the art can adapt the principles of the present invention to be used with a variety of types of terminals and/or associated viewer input devices.

On-screen directories for terminals 509 are known in the art. In one directory familiar to most viewers, a designated channel provides a comprehensive list of channels and their corresponding designations (e.g. NBC, The Discovery Channel, CNN, etc.). This directory is useful to efficiently direct the viewers to a desired channel, but provides no information to the viewers regarding the programs showing on that channel. In another directory provided by Tivo, which provides a personal video recorder service, a screen provides a synopsis of each program provided by a channel. This directory further includes a still shot taken from the program, typically of one of the principal actors or action scenes. Thus, for the viewer to determine whether the program is of interest, the viewer must read the synopsis. This process can be tedious and subject to bias (as each synopsis can be written to seem interesting). Therefore, each of the above directories, whether providing no information or biased information regarding a program, fails to give the viewer the necessary tools to determine whether a particular program will be of interest to the viewer.

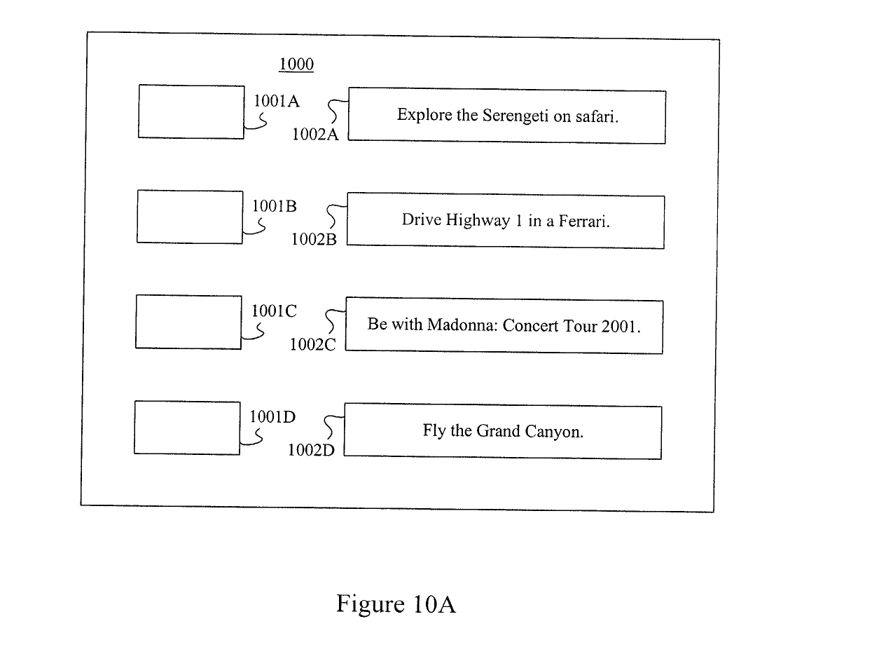

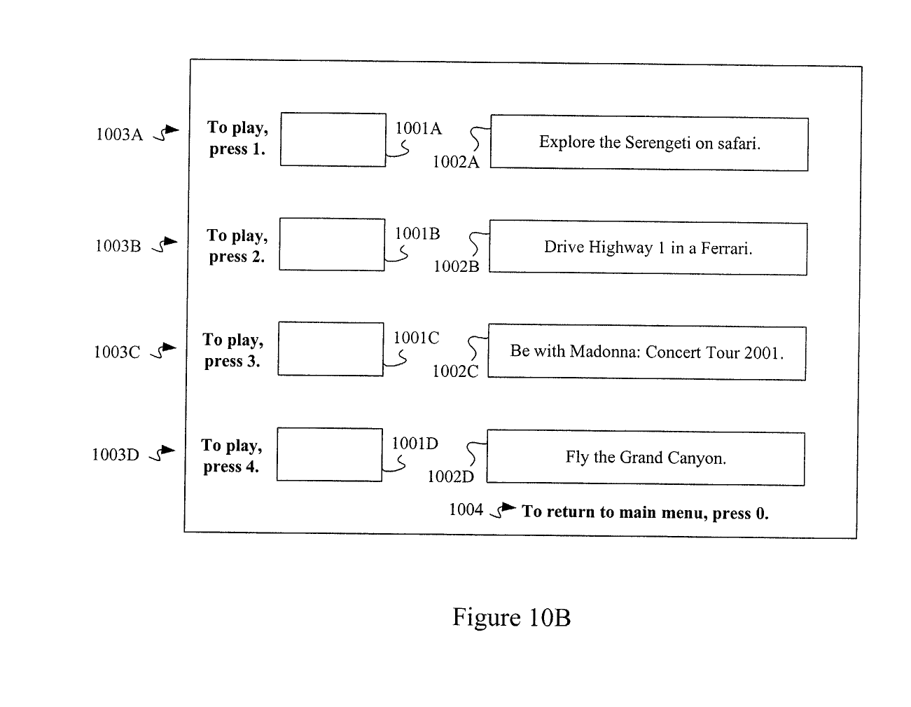

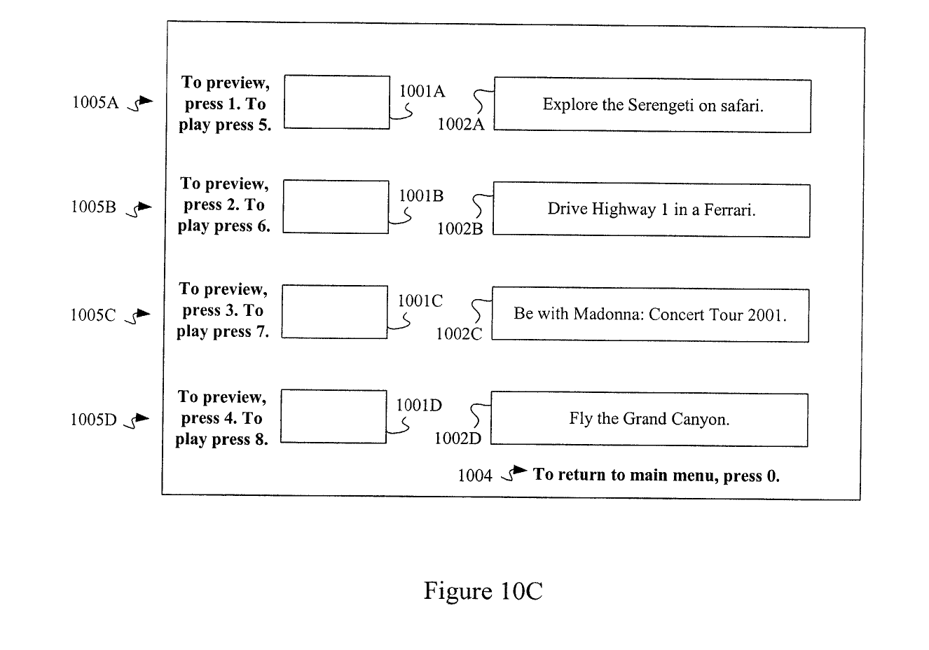

FIG. 10A illustrates one embodiment of an onscreen directory 1000 including a plurality of preview areas 1001A, 1001B, 1001C and 1001C, wherein each preview area 1001 has a corresponding textual description 1002. Specifically, preview area 1001A has a corresponding textual description 1002A, preview area 1001B has a corresponding textual description 1002B, preview area 1001C has a corresponding textual description 1002C, and preview area 1001D has a corresponding textual description 1002D. Each preview area 1001 can include a predetermined segment of a program, wherein the segment shows representative action or drama of the program. The plurality of preview areas 1001 can be simultaneously or individually active.

In the embodiment in which preview areas 1001A-1001D are simultaneously active, a viewer can select a program (i.e. run the program on another screen) by entering a corresponding number of the preview area 1001 via a viewer input device. For example, referring to FIG. 10B, preview area 1001A can be selected by pressing number 1 on the viewer input device (as indicated by guide 1003A), preview area 1001B can be selected by pressing number 2 on the viewer input device (as indicated by guide 1003B), preview area 1001C can be selected by pressing number 3 on the viewer input device (as indicated by guide 1003C), and preview area 1001D can be selected by pressing number 4 on the viewer input device (as indicated by guide 1003D). The viewer can return to another directory, such as the listing of television channels, by pressing number 0 on the viewer input device (guide 1004).

In the embodiment in which preview areas 1001A-1001D are individually active, a viewer can preview a program (i.e. activate a preview area 1001) by entering a first number via a viewer input device and select that program by entering a second number via the viewer input device. For example, referring to FIG. 10C, a viewer can preview a program described by description 1002A by pressing number 1 and can select that program by pressing number 5 on the viewer input device (as indicated by guide 1005A). The viewer can preview a program described by description 1002B by pressing number 2 and can select that program by pressing number 6 on the viewer input device (as indicated by guide 1005B). A viewer can preview a program described by description 1002C by pressing number 3 and can select that program by pressing number 7 on the viewer input device (as indicated by guide 1005C). Finally, the viewer can preview a program described by description 1002D by pressing number 4 and can select that program by pressing number 8 on the viewer input device (as indicated by guide 1005D). Once again, the viewer can return to another directory, such as the listing of television channels, by pressing number 0 on the viewer input device (as indicated by guide 1004).

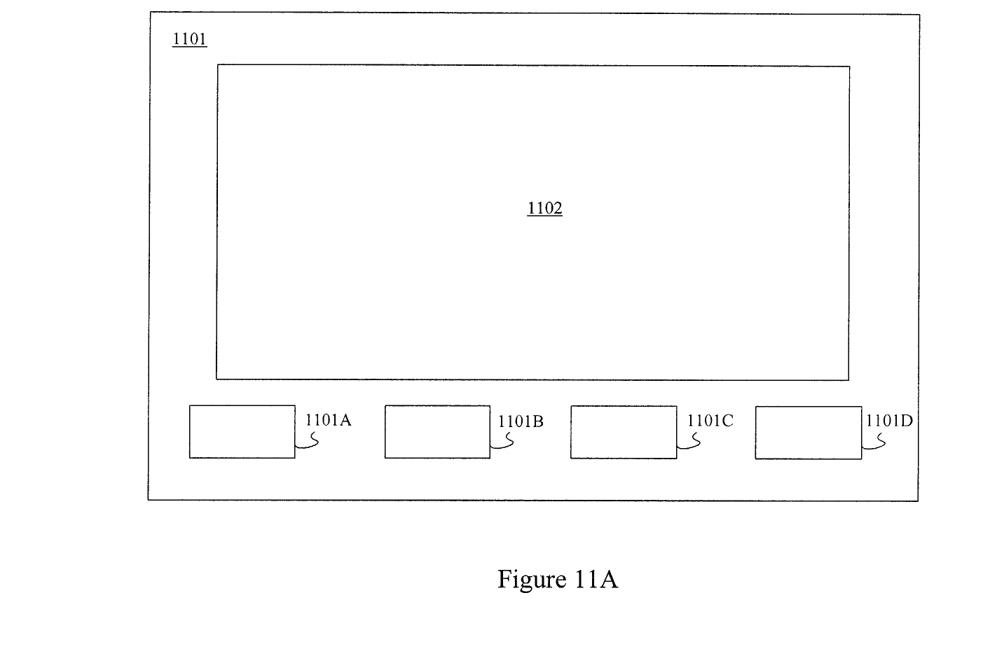

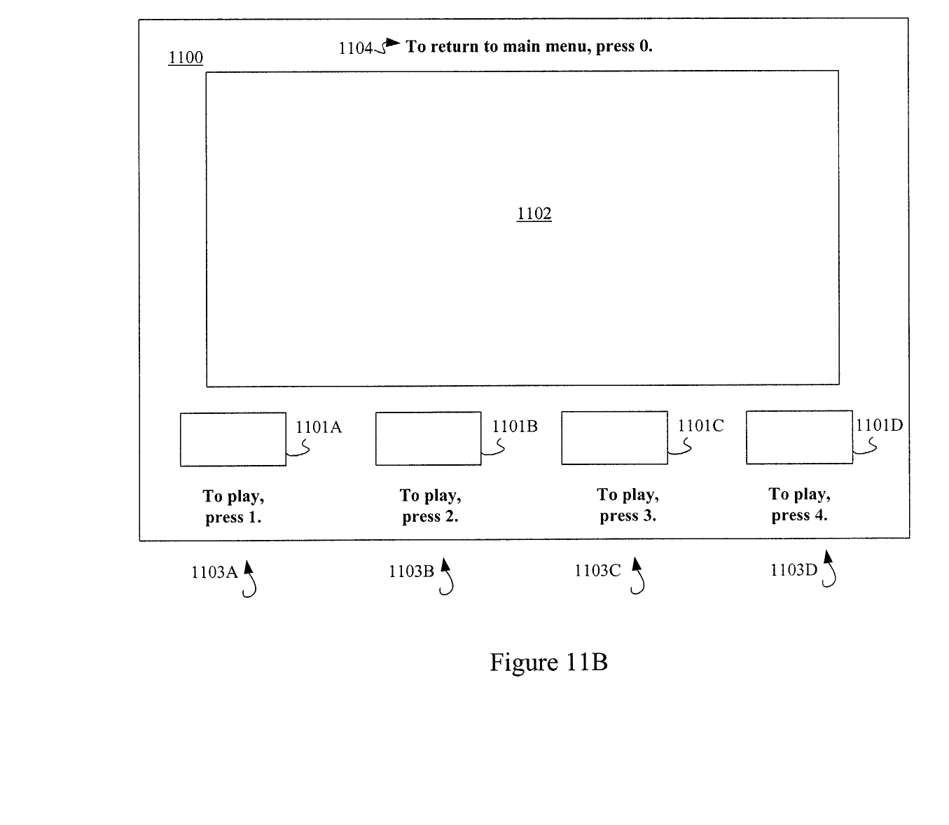

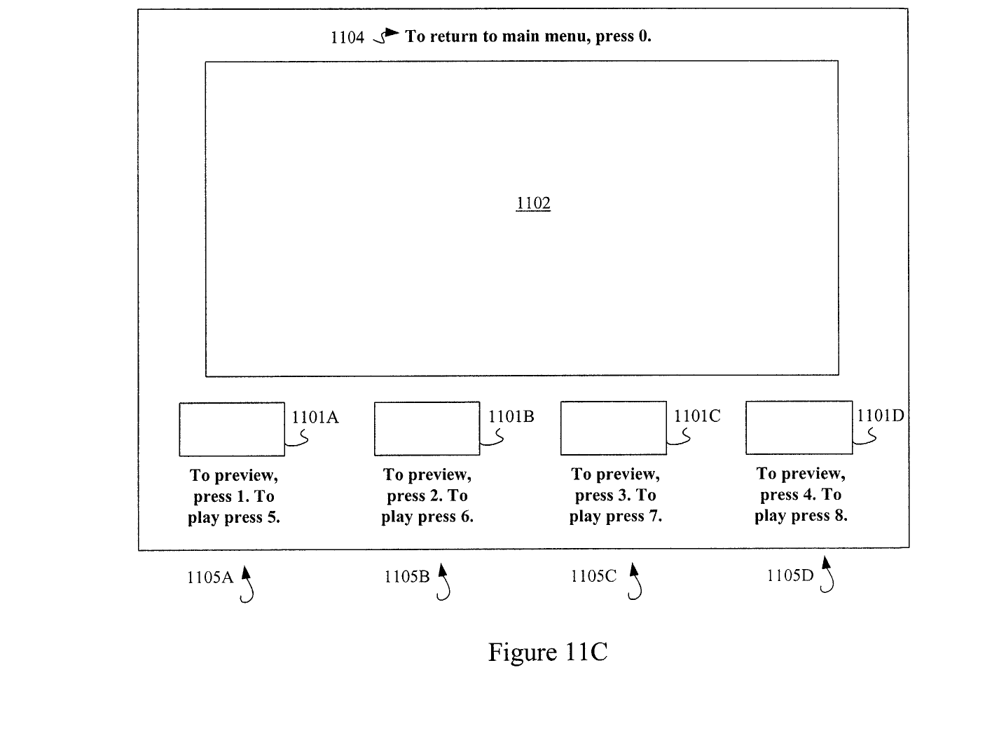

In another embodiment of the invention, an onscreen display includes a plurality of preview areas and a selected program area. For example, FIG. 11A illustrates an on-screen display 200 including a plurality of preview areas 1101A-1101D and a selected program area 1102. In this embodiment, the plurality of preview areas 1101 can be individually or simultaneously active.

In the embodiment in which preview areas 1101A-1101D are simultaneously active, a viewer can select a program (i.e. run the selected program in selected program area 1102) by entering a corresponding number of the preview area 1101 via a viewer input device. For example, referring to FIG. 11B, preview area 1101A can be selected by pressing number 1 on the viewer input device (indicated by guide 1103A), preview area 1101B can be selected by pressing number 2 on the viewer input device (indicated by guide 1103B), preview area 1101C can be selected by pressing number 3 on the viewer input device (indicated by guide 1103C), and preview area 1101D can be selected by pressing number 4 on the viewer input device (indicated by guide 1103D). The viewer can return to another directory, such as the listing of channels, by pressing number 0 on the viewer input device (indicated by guide 1104).

In the embodiment in which preview areas 1101A-1101D are individually active, a viewer can preview a program (i.e. activate a preview area 1101) by entering a first number via a viewer input device and select that program (i.e. run the program in selected program area 1102) by entering a second number via the viewer input device. For example, referring to FIG. 11C, a viewer can preview a program associated with a still shot shown in preview area 1101A by pressing number 1 and can select that program by pressing number 5 on the viewer input device (indicated by guide 1105A). The viewer can preview a program associated with a still shot shown in preview area 1101B by pressing number 2 and can select that program by pressing number 6 on the viewer input device (indicated by guide 1105B). A viewer can preview a program associated with a still shot shown in preview area 1101C by pressing number 3 and can select that program by pressing number 7 on the viewer input device (indicated by guide 1105C). Finally, the viewer can preview a program associated with a still shot shown in preview area 1101D by pressing number 4 and can select that program by pressing number 8 on the viewer input device (indicated by guide 1105D). Once again, the viewer can return to another directory, such as the listing of television channels, by pressing number 0 on the viewer input device (indicated by guide 1104).

Typically, selected program area 1102 is larger than each of the plurality of preview areas 1101. In one embodiment (not shown), using the viewer input device, selected preview area 1102 can be further enlarged to encompass an entire screen.

The on-screen directories described in the embodiments illustrated in FIGS. 10A-10C and 11A-11C provide significant advantages over the known art. Specifically, a preview provides significantly more information than a mere listing of channels and their designations. Moreover, unlike those listings relying on written descriptions, a preview provides unbiased information to the viewer. Thus, the on-screen directory of the present invention, by showing representative action or drama of the program, allows the viewer to quickly identify a program of interest.

On-Screen Directories Including Immersive Content

In accordance with one feature of the invention, one or more programs can include immersive content, as described in detail above. In one embodiment, the previews can include various aspects of the same “event” (thus, as used herein, the term “program” can refer to an identifiable aspect of any event). For example, assuming an event is a live broadcast of a football game, each of the previews could focus on a specific part of the game, such as the defensive line of team A, the offensive play of team B, crowd reaction, etc. In this embodiment, immersive content creation unit 501 (FIG. 5) could capture the multiple environment maps using multiple cameras and central equipment 503 could choreograph and compress the incoming immersive data streams in parallel. For example, multiple operators could be used to choreograph the incoming immersive video streams, wherein one operator could determine what the viewers see regarding that specific aspect of the event. In one embodiment, signal processing 507 can include multiplexing the plurality of choreographed immersive video streams for transmission to cable system 508. In this case, cable system 508 could include known components (not shown) for transmitting each choreographed immersive video stream as a preview. Note that because of their digital format the plurality of choreographed immersive video streams can be transmitted on a single cable television channel, telephone line, etc.

Although the present invention has been described in detail with respect to certain embodiments, those skilled in the art will recognize modifications and variations that are within the scope of the present invention. For example, although the above-described on-screen directories activate previews or selecto program using numeric characters on a viewer input device, other embodiments of the invention can use other means for activation/selection. Specifically, such means can include, but is not limited to, the use of any button, key, cursor, or menu provided on or in association with the viewer input device. Therefore, the present invention is defined only by the appended claims.

1. A method of transmitting an immersive video stream, the method comprising:
choreographing the immersive video stream;
identifying relevant macroblocks of the immersive video stream based on choreographing the immersive video stream; and
compressing the relevant macroblocks.

2. The method of claim 1, wherein choreographing is performed by an operator.

3. The method of claim 1, wherein choreographing is performed by software.

4. The method of claim 1, wherein choreographing includes determining at least one view window for the immersive video stream.

5. The method of claim 1, further including processing the immersive video stream.

6. The method of claim 5, wherein processing includes multiplexing multiple immersive video streams.

7. The method of claim 6, further including de-multiplexing the multiple video streams for display.

8. The method of claim 1, further including decompressing the relevant macroblocks.

9. A program transmission system, wherein the program includes immersive content, the system comprising:
means for receiving and choreographing the immersive content;
a macroblock selection unit, wherein each selected macroblock corresponds to a relevant macroblock of the immersive content as determined by the means for receiving and choreographing; and
a compression unit to compress the selected macroblocks for transmission.

10. The system of claim 9, further including a cable system that receives an output of the compression unit.

11. The system of claim 10, wherein the cable system includes at least one terminal for displaying the immersive content.

12. The system of claim 11, wherein the terminal includes a decompression unit to decompress the selected macroblocks.

13. The system of claim 12, wherein the terminal displays a plurality of previews associated with at least one program, and wherein at least one preview includes immersive content.

14. The system of claim 13, wherein the plurality of previews are simultaneously active.

15. The system of claim 14, wherein the plurality of previews are individually active.

16. The system of claim 13, further including a multiplexer to receive the plurality of previews and provide the plurality of previews to the cable system.

17. An on-screen directory including:
a plurality of preview areas, wherein each preview area includes a predetermined segment from a program; and
a plurality of corresponding textual descriptions.

18. The on-screen directory of claim 17, wherein the predetermined program segment shows one of drama and action.

19. The on-screen directory of claim 17, wherein the plurality of preview areas are simultaneously active.

20. The on-screen directory of claim 19, wherein the plurality of preview areas include means to facilitate selection of the program.

21. The on-screen directory of claim 20, further including means to activate another directory.

22. The on-screen directory of claim 17, wherein the plurality of preview areas are individually active.

23. The on-screen directory of claim 22, wherein each preview area includes means for activating a preview of the program and means for selecting the program.

24. The on-screen directory of claim 23, further including means for activating another directory.

25. An on-screen directory including:
a plurality of preview areas, wherein each preview area includes a predetermined segment from a program; and
a selected program area.

26. The on-screen directory of claim 25, wherein the plurality of preview areas are simultaneously active.

27. The on-screen directory of claim 26, wherein each preview area includes means for selecting the program.

28. The on-screen directory of claim 27, further including means for activating another directory.

29. The on-screen directory of claim 25, wherein the plurality of preview areas are individually active.

30. The on-screen directory of claim 29, wherein each preview area includes means for activating a preview of the program and means for selecting the program.

31. The on-screen directory of claim 30, further including means for activating another directory.

32. The on-screen directory of claim 25, wherein the selected preview area is larger than each of the plurality of preview areas.

33. An on-screen directory including:
means for providing previews of a plurality of programs; and
means for providing textual descriptions corresponding to the plurality of programs.

34. The on-screen directory of claim 33, wherein each preview shows one of drama and action from a program.

35. The on-screen directory of claim 33, wherein the plurality of previews are running simultaneously.

36. The on-screen directory of claim 35, further including at least one guide that indicates how to select a program.

37. The on-screen directory of claim 36, further including another guide that indicates how to activate another directory.

38. The on-screen directory of claim 33, wherein each preview is selectively active.

39. The on-screen directory of claim 38, further including:
a first guide for each preview, the first guide indicating how to activate a preview of a program; and
a second guide for each preview, the second guide indicating how to select the program.

40. The on-screen directory of claim 39, further including another guide indicating a predetermined button to activate another directory.

41. An on-screen directory including:
means for showing previews of a plurality of programs; and
means for showing a selected program area.

42. The on-screen directory of claim 41, wherein the previews are simultaneously active.

43. The on-screen directory of claim 42, further including at least one guide indicating how to select a program.

44. The on-screen directory of claim 43, further including another guide indicating how to activate another directory.

45. The on-screen directory of claim 41, wherein each preview is selectively active.

46. The on-screen directory of claim 45, further including a first guide to indicate how to activate the preview of the program and a second guide to indicate how to select the program.

47. The on-screen directory of claim 46, further including another guide indicating how to activate another directory.

48. The on-screen directory of claim 41, wherein the selected preview area is larger than each of the plurality of preview areas.

49. An on-screen directory including:
a plurality of previews showing representative action or drama from a plurality of programs.

50. The on-screen directory of claim 49, wherein at least one program includes an immersive feature.

51. A method for providing on-screen program information, the method including:
providing on-screen previews from a plurality of programs.

52. The method of claim 51, further including:
providing textual descriptions corresponding to the plurality of programs.

53. The method of claim 51, wherein each on-screen preview shows one of drama and action from a program.

54. The method of claim 51, wherein the on-screen previews are running simultaneously.

55. The method of claim 54, further including providing at least one guide for selecting a program from the on-screen previews.

56. The method of claim 55, further including providing a guide for accessing another directory.

57. The method of claim 51, wherein the on-screen previews are selectively active.

58. The method of claim 57, further including:
providing a first guide for activating an on-screen preview using a viewer input device; and
providing a second guide for selecting the program using the viewer input device.

59. The method of claim 51, further including providing a selected program area.

60. The method of claim 59, wherein the selected preview area is larger than each of previews.

61. The method of claim 51, wherein at least one of the onscreen previews includes an immersive feature.
